(19) United States
(12) Patent Application Publication
(10) Pub. No.: US 2009/0101769 A1
(43) Pub. Date: Apr. 23, 2009

(54) ARRANGEMENT FOR MOUNTING A LINEAR ELECTRIC MOTOR STAND

(75) Inventors: Guillaume Duchemin, Octeville sur Mer (FR); Didier Mougin, Octeville sur Mer (FR)

Correspondence Address: YOUNG & THOMPSON, 209 Madison Street, Suite 500, ALEXANDRIA, VA, 22314, US

(73) Assignee: SIDEL PARTICIPATIONS, OCTEVILLE SUR MER (FR)

(21) Appl. No.: 12/297,779

(22) PCT Filed: Apr. 17, 2007
(86) PCT No.: PCT/EP07/53700

§ 371 Date: Nov. 7, 2008

(30) Foreign Application Priority Data
Apr. 20, 2006 (FR) 0651392

(51) Int. Cl. F16M 11/24

(52) U.S. Cl. 248/157

(57) ABSTRACT

An arrangement (10) for mounting a stand (12) for a linear electric motor (14) includes a primary winding (18) secured to the stand (12) and a secondary winding (20) secured to a structure (16), of the type wherein the vertical stand (12) is mounted mobile on the structure (16) along a longitudinal displacement direction via guide elements (22) and including a main board (24) bearing the primary winding (18) and at least one upper fastening wing (26) including part (28) of the guide elements (22) designed to co-operate with another complementary part (20) in the structure (16). The stand (12) is suspended relative to the structure (16) via upper guide elements (22), such that the stand (12) is capable of freely expanding along a main expanding direction, that is vertically downwards to compensate the thermal expansion of the material of the stand (12) under the effect of heating of the primary winding (18) and such that the upper guide elements (22) are not affected.

The present invention relates to an arrangement for the mounting of a linear electric motor stand.

The present invention relates more particularly to an arrangement for the mounting of a stand of a linear electric motor comprising a primary secured to the stand and a secondary secured to a structure, of the type in which the stand extends vertically and is mounted so as to be movable on the structure in a longitudinal direction of movement by means of guide means and of the type in which the vertical stand comprises a main plate supporting the primary and at least one first coupling wing called the upper coupling wing comprising a portion of the guide means designed to interact with another matching portion that the structure comprises.

Many arrangements are known for the mounting of a linear electric motor, particularly a linear motor of the “flat” type.

Document DE 10.2004.036.992 describes for example an arrangement of the aforementioned type, in which the primary of the linear motor is attached to a supporting plate which is mounted so as to be movable relative to a fixed stand. The supporting plate supporting the primary comprises guide elements capable of interacting with two parallel rails secured to the fixed stand.

In this document, the connection between the guide elements and the supporting plate is achieved by means of compensation elements of a first and a second type which are capable of deforming respectively in at least one determined direction in order to absorb the thermal expansion in order to prevent transmitting to the guide means the corresponding forces which would affect the operation thereof.

In addition, the machines, such as the packaging machines, conventionally comprise a transfer device which, consisting of belts or chains driven by an asynchronous electric motor, is for example designed to convey the packages between various workstations of the machine.

Linear motors have never been used to produce a transfer device, particularly for carrying out operations that are successive and repeated at high rates, because of the technical problems amongst which will be cited the heating of the motor as a prohibitive problem for such applications.

The known solutions of the prior art do not provide full satisfaction, in particular for applications requiring repeated movements at high rates and are more often complex and costly to apply.

The object of the present invention is to propose, contrary to the prejudices of the prior art, a new arrangement for the mounting of a linear motor stand which is notably simple and reliable while being capable of fully compensating for the thermal expansion caused by the heating of the primary.

For this purpose, the invention proposes an arrangement for the mounting of a linear stand of the type described above, characterized in that the stand is suspended relative to the structure by means of guide means, called upper guide means such that the stand is capable of expanding freely in a main direction of expansion, that is to say vertically downward in order to compensate for the thermal expansion of the material of the stand under the effect of the heating of the primary and that the upper guide means are not affected.

Advantageously, the overhung mounting of the stand which is suspended relative to the structure makes it possible to simplify the guide means by using only one guide rail, which makes it possible to reduce the number of components thereof and incidentally the cost.

Thanks to the arrangement according to the invention, it is no longer necessary to have recourse to using complex and costly compensation means which, in addition, are capable of absorbing the thermal expansion forces in a limited manner only.

According to other features of the invention:
the guide means are arranged between the upper coupling wing and the portion of the structure situated transversely opposite such that the stand is suspended relative to the structure;
the guide means consist respectively of an upper longitudinal rail which is secured to the structure and of matching movable means, such as skids, that are secured to the upper coupling wing;
the lower free portion of the main plate of the stand forms a deformable zone designed, when the primary heats up in operation, to allow the thermal expansion of the material of the stand in the main vertical direction of expansion and in a directional orientation opposite to the upper coupling wing;
the stand comprises a second wing, called the lower wing, extending vertically downward from the main plate and the lower wing forms the deformable zone of the stand;
the lower wing of the stand comprises positioning means which, secured to the second lower wing, are free to move relative to the structure in the vertical direction of expansion when there is thermal expansion of the stand and that are capable of moving longitudinally along an element supported by the structure so as to reinforce the mechanical strength of the stand and to maintain a constant air gap in the transverse direction while compensating for the attraction forces being exerted between the primary and the secondary;
the stand belongs to a transfer device of a packaging machine comprising means, such as a member for picking up a package, which are secured to the stand so as to be moved longitudinally.

Other features and advantages of the invention will appear on reading the following detailed description, for the understanding of which reference will be made to the appended drawings in which:

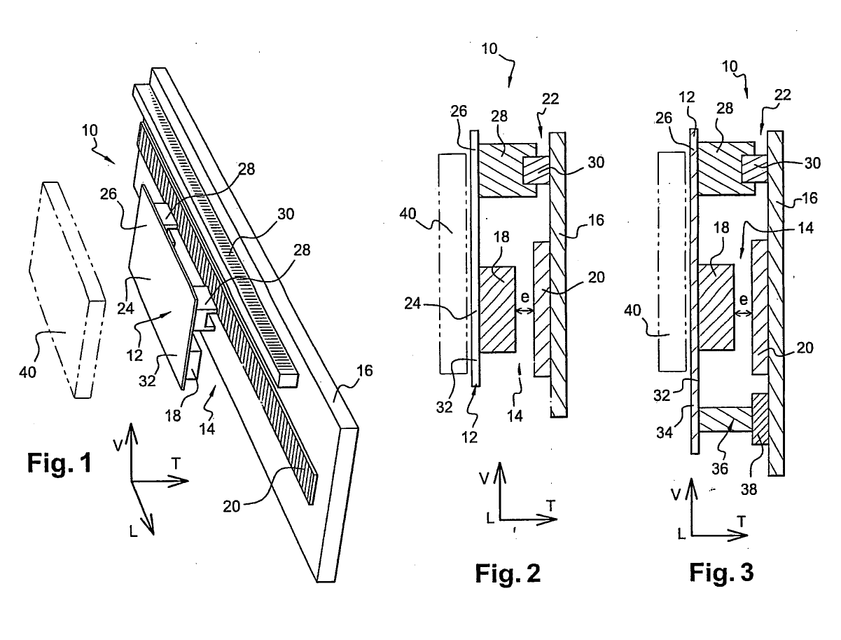

FIG. 1 is a view in perspective which schematically represents an arrangement in an exploded view comprising a linear motor and a stand according to the invention which is mounted so as to be movable on a structure;

FIG. 2 is a view in cross section along a vertical plane of the arrangement of FIG. 1 represented in the assembled position;

FIG. 3 is a view in cross section similar to FIG. 2 representing a variant embodiment.

In the following description, identical reference numbers indicate parts that are identical or have similar functions.

For the description of the invention, the description will adopt, in a nonlimiting manner and in order to make it easier to understand, the longitudinal, vertical and transverse directions according to the indicator (L, V, T) indicated in the figures and in which the vertical direction does not necessarily refer to the direction of gravity.

FIG. 1 shows an arrangement 10 comprising mainly a stand 12 for a linear motor 14 according to a preferred embodiment of mounting according to the invention and a portion of a structure 16, such as a frame of a machine (not shown).

The linear electric motor 14 is a linear motor of the “flat” type which consists respectively of a primary 18 of generally parallelepipedal shape and a secondary 20.

Preferably, the primary 18 is secured to the stand 12 so as to form an item of equipment that can be moved relative to the structure 16 to which the secondary 20 is secured.

According to the indicator (L, V, T) represented in the figures, the stand 12 supporting the primary 18 is generally in the form of a parallelepipedal plate and extends for example in this instance in a vertical plane.

The secondary 20 is arranged vertically and transversely opposite the primary 18 at a transverse distance corresponding to a determined air gap value “e”.

The secondary 20 in this instance extends in a rectilinear manner in the longitudinal direction to form a magnet path determining the path of movement of the stand 12 and of the primary 18 relative to the structure 16.

The stand 12 is mounted so as to be movable on the structure 16 relative to which it moves horizontally in the longitudinal direction by means of the guide means 22.

The stand 12, vertical in this instance, comprises a main plate 24 supporting the primary 18 and at least one first coupling wing 26, called the upper coupling wing.

The main guide means 22 are arranged vertically above the primary 18 between the first upper coupling wing 26 of the stand 12 and the structure 16.

The first upper coupling wing 26 comprises a movable portion of the guide means 22 designed to interact with another matching fixed portion that the structure 16 comprises, the movable portion in this instance consisting of front and rear skids 28 which are capable of sliding on a longitudinal rail 30, called the upper rail.

According to the invention, the stand 12 is suspended relative to the structure 16 by means of guide means, called upper guide means 22 such that the stand 12 is capable of expanding freely in a main direction of expansion, that is to say vertically downward in order to compensate for the thermal expansion of the material of the stand 12 under the effect of the heating of the primary 18 and such that the upper guide means 22 are not affected.

According to the invention and as Illustrated in the figures, the stand 12 extends vertically and generally parallel to the structure 16, the stand 12 being suspended relative to said structure 16 by means of said upper guide means 22 so that the portion of the stand 12 extending vertically beneath the upper coupling wing 26 is free to expand downward under the effect of the heating of the primary 18 transmitted notably to the central plate 24 of the stand 12.

Thanks to this arrangement 10, the stand 12 is therefore free to expand in order to fully compensate for the thermal expansion of the material of the stand 12.

As can be seen better in FIG. 2, the free lower portion of the main plate 24 of the stand 12 forms a deformable zone 32 designed, when the primary 18 heats up in operation, to allow the thermal expansion of the material of the stand 12 in the main vertical direction of expansion and in a directional orientation opposite to the upper coupling wing 26.

When, in operation, the primary 18 heats up, a considerable quantity of heat is transmitted by conduction to the main plate 24 and causes the material to expand.

FIG. 3 represents a variant embodiment in which the stand 12 comprises a second wing 34, called the lower coupling wing, extending vertically downward from the main plate 24.

According to this variant, the deformable zone 32 of the stand 12 consists mainly of said second lower wing 34.

Advantageously, the second lower wing 34 of the stand 12 comprises positioning means 36 which interact with the structure 16 and which, secured to the second lower wing 34, are free to move in the vertical direction of expansion when there is thermal expansion of the stand 12.

The positioning means 36 comprise a spacer which is capable of moving longitudinally, for example by means of a roller (not shown), along an element 38 forming a track supported by the structure 16.

The positioning means 36 make it possible notably to reinforce the mechanical strength of the stand 12 and to maintain an air gap “e” in the transverse direction which is constant while compensating for the forces of attraction being exerted between the primary 18 and the secondary 20.

According to an exemplary application, the stand 12 belongs to a transfer device of a packaging machine comprising means 40, such as a member for picking up a package, that are secured to the stand so as to be moved, in this instance longitudinally.

Advantageously, a linear motor is capable, in such a transfer device, of moving the pick-up members while obtaining considerable accelerations, a high speed of movement and a great accuracy in positioning.

Naturally, the embodiment of the invention described and represented is given only as a nonlimiting example.

Therefore, without departing from the context of the invention, it is possible to invert the structure so that the stand 12 forming the portion mounted so as to be movable relative to the structure 16 supports the secondary 20 and the primary 18 is secured to the structure 16.

Advantageously, it is then not necessary to provide additional means, of the cable-holder type, for the power supply cables of the primary 18 since it is attached to the structure 16.

1. An arrangement (10) for the mounting of a stand (12) of a linear electric motor (14) comprising a primary (18) secured to the stand (12) and a secondary (20) secured to a structure (16), of the type in which the stand (12) extends vertically and is mounted so as to be movable on the structure (16) in a longitudinal direction of movement by means of guide means (22) and of the type in which the stand (12) comprises a main plate (24) supporting the primary (18) and at least one first coupling wing called the upper coupling wing (26) comprising a portion (28) of the guide means (22) designed to interact with another matching portion (30) that the structure (16) comprises, characterized in that the stand (12) is suspended relative to the structure (16) by means of guide means, called upper guide means (22) such that the stand (12) is capable of expanding freely in a main direction of expansion, that is to say vertically downward in order to compensate for the thermal expansion of the material of the stand (12) under the effect of the heating of the primary (18) and that the upper guide means (22) are not affected.

2. The arrangement as claimed in claim 1, characterized in that the guide means (22) are arranged between the upper coupling wing (26) and the portion of the structure (16) situated transversely opposite such that the stand (12) is mounted suspended relative to the structure (16).

3. The arrangement as claimed in claim 2, characterized in that the guide means (22) consist respectively of an upper longitudinal rail (30) which is secured to the structure (16) and of matching movable means (28), such as skids, that are secured to the upper coupling wing (26).

4. The arrangement as claimed in claim 1, characterized in that the lower free portion of the main plate (24) of the stand (12) forms a deformable zone (32) designed, when the primary (18) heats up in operation, to allow the thermal expansion of the material of the stand (12) in the main vertical direction of expansion and in a directional orientation opposite to the upper coupling wing (26).

5. The arrangement as claimed in claim 4, characterized in that the stand (12) comprises a second wing, called the lower wing (34), extending vertically downward from the main plate (24) and in that the lower wing (34) forms the deformable zone (32) of the stand (12).

6. The arrangement as claimed in claim 5, characterized in that the lower wing (34) of the stand (12) comprises positioning means (36) which, secured to the second lower wing (34), are free to move relative to the structure (16) in the vertical direction of expansion when there is thermal expansion of the stand (12) and that are capable of moving longitudinally along an element (38) supported by the structure (16) so as to reinforce the mechanical strength of the stand (12) and to maintain a constant air gap (e) in the transverse direction while compensating for the attraction forces being exerted between the primary (18) and the secondary (20).

7. The arrangement as claimed in claim 1, characterized in that the stand (12) belongs to a transfer device of a packaging machine comprising means (40), such as a member for picking up a package, which are secured to the stand so as to be moved longitudinally.

8. The arrangement as claimed in claim 2, characterized in that the lower free portion of the main plate (24) of the stand (12) forms a deformable zone (32) designed, when the primary (18) heats up in operation, to allow the thermal expansion of the material of the stand (12) in the main vertical direction of expansion and in a directional orientation opposite to the upper coupling wing (26).

9. The arrangement as claimed in claim 3, characterized in that the lower free portion of the main plate (24) of the stand (12) forms a deformable zone (32) designed, when the primary (18) heats up in operation, to allow the thermal expansion of the material of the stand (12) in the main vertical direction of expansion and in a directional orientation opposite to the upper coupling wing (26).

11. The arrangement as claimed in claim 2, characterized in that the stand (12) belongs to a transfer device of a packaging machine comprising means (40), such as a member for picking up a package, which are secured to the stand so as to be moved longitudinally.
